(19) United States
(12) Patent Application Publication
(10) Pub. No.: US 2017/0184057 A1
(43) Pub. Date: Jun. 29, 2017

(54) Valve Unit With Purge Air Pump

(71) Applicant: CONTINENTAL AUTOMOTIVE GMBH, Hannover (DE)

(72) Inventors: Manfred Weigl, Sinzing (DE); Philippe Grass, Regensburg (DE)

(73) Assignee: Continental Automotive GmbH, Hannover (DE)

(21) Appl. No.: 15/119,175

(22) PCT Filed: Aug. 5, 2015
(86) PCT No.: PCT/EP2015/068010

§ 371 Date: Aug. 16, 2016

(30) Foreign Application Priority Data
Aug. 19, 2014 (DE) 10 2014 216 454.0

(51) Int. Cl. F02M 25/08; F02M 25/00

(52) U.S. Cl. CPC F02M 25/08; F02M 25/00

(57) ABSTRACT

The present disclosure relates to internal combustion engines in general. Some embodiments of the teaching may include valve units for use in a fuel tank system of an internal combustion engine having a fuel tank and a storage element for temporary storage of hydrocarbons, wherein the fuel tank and the storage element are connected together such that the hydrocarbons which gasify out of a fuel in the fuel tank are stored in the storage element. They may include a purge air pump connected to the storage element and conveying fresh air to the storage element, thereby releasing the stored hydrocarbons and supplying them to a combustion chamber of the internal combustion engine and a movable adjustment element with at least two positions. The first position may connect a pressure side of the purge air pump to a first line and a suction side of the purge air pump to a second line. The second position may connect the pressure side to the second line and the suction side to the first line.

### CROSS-REFERENCE TO RELATED APPLICATIONS

This application is a U.S. National Stage Application of International Application No. PCT/EP2015/068010 filed Aug. 5, 2015, which designates the United States of America, and claims priority to DE Application No. 10 2014 216 454.0 filed Aug. 19, 2014, the contents of which are hereby incorporated by reference in their entirety.

### TECHNICAL FIELD

The present disclosure relates to internal combustion engines in general. Some embodiments of the teaching may include valve units with a purge air pump for use in the fuel tank system of an internal combustion engine.

### BACKGROUND

To reduce pollutant emissions from motor vehicles, in recent decades numerous measures have been introduced. One of these measures is to use a fuel tank system in which a fuel tank is connected to a storage element for temporary storage of hydrocarbons. When refueling motor vehicles with hydrocarbon-based fuels, the hydrocarbons gasify out of the fuel, wherein the hydrocarbons should not enter the atmosphere. At high temperatures or when driving over uneven ground, there is increased gasification of hydrocarbons from the fuel, wherein it must be effectively ensured that these hydrocarbons do not escape to the atmosphere. In particular in hybrid vehicles, in which the internal combustion engine is completely shut down for long distances, the gasified hydrocarbons must be temporarily stored effectively in order to be burned later when the internal combustion engine restarts.

For these applications, fuel tank systems have proved useful which consist of a fuel tank and a storage element for temporary storage of hydrocarbons, wherein the fuel tank and the storage element are connected together such that the hydrocarbons which gasify out of a fuel present in the fuel tank are stored in the storage element, wherein the storage element is connected to a first line through which fresh air can be conveyed to the storage element, and the storage element is connected to a second line which connects the storage element to an intake tract of the internal combustion engine and through which the fresh air enriched with hydrocarbons can be conveyed from the storage element to the intake tract.

In this way, the storage element can be flushed cyclically with fresh air, and the hydrocarbons stored can be supplied to an intake tract which connects the internal combustion engine to the air filter and which supplies the internal combustion engine with air for combustion. Thus the hydrocarbons gasified out of the fuel tank can be burned in the internal combustion engine, and the escape of hydrocarbons to atmosphere is securely prevented. To convey the hydrocarbons from the storage element to the intake tract, according to the prior art a purge air pump is used, which may for example be configured as a radial pump. In order to guarantee fault-free function of the fuel tank system, it is necessary to check the tightness of the entire fuel tank system regularly. This tightness test cannot be restricted to workshop visits of the motor vehicle, but the tightness test must be carried out in the vehicle, i.e. on board, throughout the driving operation of the motor vehicle.

### SUMMARY

It is therefore an object of the present disclosure to describe an economic valve unit with a purge air pump which is configured such that the tightness of a fuel tank system can be checked regularly during driving operation of the motor vehicle.

Some embodiments of the present teaching may include a valve unit (9) with a purge air pump (7) for use in the fuel tank system (1) of an internal combustion engine (2) with a fuel tank (16) and a storage element (19) for temporary storage of hydrocarbons (23), wherein the fuel tank (16) and the storage element (5) are connected together such that the hydrocarbons (23), which gasify out of a fuel (17) present in the fuel tank (16), are stored in the storage element (19), wherein the storage element (19) is connected to the purge air pump (7) which has a suction side (21) and a pressure side (22), wherein fresh air (24) can be conveyed to the storage element (19) by the purge air pump (7), whereby the hydrocarbons (23) are released from the storage element and supplied to the internal combustion engine for combustion, characterized in that the valve unit (9) has an adjustment element (27) which is mounted movably in the valve unit (9), wherein the purge air pump (7) is connected to the valve unit (9) such that in a first position of the adjustment element (27), a first adjustment element passage (31) connects the pressure side (22) of the purge air pump (7) to a first line (29) and a second adjustment element passage (32) connects the suction side (21) of the purge air pump (7) to a second line (30), and that in a second position of the adjustment element (27), a third adjustment element passage (33) connects the pressure side (22) of the purge air pump (7) to a second line (30) and a fourth adjustment element passage (34) connects the suction side (21) of the purge air pump (7) to a first line (29).

In some embodiments, in a third position of the adjustment element (27), the adjustment element (27) separates the suction side (21) and the pressure side (22) of the purge air pump (7) from the first line (29) and/or from the second line (30).

In some embodiments, the adjustment element (27) has a fifth adjustment element passage (40) and a sixth adjustment element passage (41), wherein the cross-sections of the fifth adjustment element passage (40) and the sixth adjustment element passage (41) are smaller than the cross-sections of the first adjustment element passage (31) and the second adjustment element passage (32).

In some embodiments, in a fourth position of the adjustment element (27), the fifth adjustment element passage (40) connects the pressure side (22) of the purge air pump (7) to a first line (29), and a sixth adjustment element passage (41) connects the suction side (21) of the purge air pump (7) to a second line (30).

In some embodiments, the purge air pump (7) is configured as a radial pump.

In some embodiments, the storage element (19) is configured as an active charcoal filter.

In some embodiments, a pressure sensor (8) is arranged in the fuel tank system (1).

Because the valve unit has a valve cylinder which is mounted rotatably about its rotation axis in the valve unit, wherein the purge air pump is connected to the valve unit such that in a first position of the valve cylinder, a first valve cylinder passage connects the pressure side of the purge air pump to a first line and a second valve cylinder passage connects the suction side of the purge air pump to a second line, and that in a second position of the valve cylinder, a third valve cylinder passage connects the pressure side of the purge air pump to a second line and a fourth valve cylinder passage connects the suction side of the purge air pump to a first line, a single pump can be used both for purging the storage element in the fuel system and for testing the tightness of the fuel system.

If, in a third position of the valve cylinder, the valve cylinder separates the suction side and the pressure side of the purge air pump from the first line and/or from the second line, the valve unit may, in addition to the functions described above, also be used as a shut-off valve.

In the valve cylinder has a fifth valve cylinder passage and a sixth valve cylinder passage, wherein the cross-sections of the fifth valve cylinder passage and the sixth valve cylinder passage are smaller than the cross-sections of the first valve cylinder passage and the second valve cylinder passage.

If, in a fourth position of the valve cylinder, the fifth valve cylinder passage connects the pressure side of the purge air pump to the first line and a sixth valve cylinder passage connects the suction side of the purge air pump to the second line, a very gentle purging of the storage element can take place. Because of the low volume flows of the fresh air which can be finely regulated with the purge air pump, the hydrocarbons can be released very evenly from the storage element, whereby it can be ensured that an optimum air/fuel mix can be set in the combustion chambers of the internal combustion engine by means of the lambda control system, although additional hydrocarbons may reach the combustion chambers from the purging of the storage element.

### BRIEF DESCRIPTION OF THE DRAWINGS

An advantageous embodiment of the invention is described with reference to the figures.

FIG. 1 shows an internal combustion engine with a fuel tank system according to the teachings of the present disclosure,

FIG. 2 shows a first position of the valve cylinder,

FIG. 3 shows a second position of the valve cylinder,

FIG. 4 shows a third position of the valve cylinder,

FIG. 5 shows a fourth position of the valve cylinder.

### DETAILED DESCRIPTION

In some embodiments, the purge air pump is configured as a radial pump. A radial pump has an easily reproducible ratio between the pressure it generates and the rotation speed with which it is driven or the power which it absorbs, if the physical parameters, for example the temperature, of the conveyed air are known. Thus the positive pressure generated in the fuel tank system can easily be monitored by the control unit on the basis of the power consumption of the radial pump.

In some embodiments, the storage element is configured as an active charcoal filter. Hydrocarbons can adhere well to active charcoal, in particular in granular form, and thus be temporarily stored.

In some embodiments, a pressure sensor is arranged in the fuel tank system. The pressure sensor allows simple testing of the tightness of the fuel tank system.

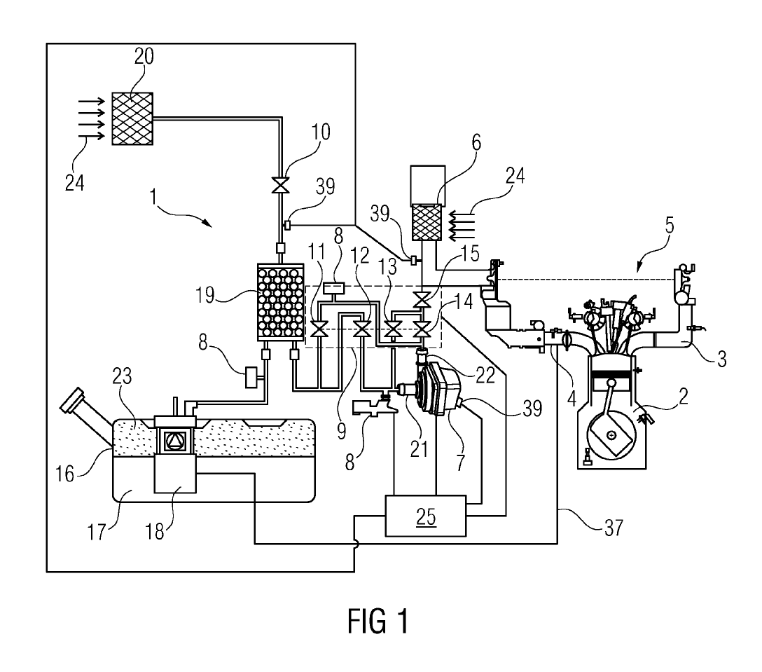

FIG. 1 shows an internal combustion engine 2 with a fuel tank system 1 according to the teachings of the present disclosure. The internal combustion engine 2 has an exhaust tract 3 and an intake tract 4. To recover the kinetic energy contained in the exhaust gas, the exhaust tract is equipped with a turbocharger which can compress the intake air in the intake tract 4. The internal combustion engine 2 is supplied with fresh air 24 via the intake tract 4. Starting from the fresh air side, fresh air 24 is guided via an air filter 6 into the intake tract 4 and may be compressed using the exhaust turbocharger 5 or a compressor and then supplied to the combustion chambers of the internal combustion engine 2. In addition, fuel 17 is supplied to the internal combustion engine 1 from the fuel tank 16 via a fuel line 37.

FIG. 1 furthermore shows the fuel tank system 1 with the fuel tank 16 and a storage element 19 for temporary storage of hydrocarbons 23. The fuel tank 16 and the storage element 19 are connected together such that the hydrocarbons 23, which gasify out of the fuel 17 in the fuel tank 16, can be stored in the storage element 19.

The storage element 19 may for example be configured as an active charcoal store. An active charcoal store is a closed canister in which normally granular carbon is arranged, so that the hydrocarbons 23 to be stored are deposited onto the carbon. The storage element 19 however only has a limited storage capacity, so the storage element 19 must be evacuated regularly in that fresh air 24 is drawn in, e.g., via a purge air filter 20, and aspirated or pressed into the storage element 19 via a line by means of the purge air pump 7. The fresh air 24 flows through the active charcoal in the storage element 19 and collects the hydrocarbons 23, whereupon the fresh air 20 enriched with hydrocarbons 23 is conveyed along further lines to the intake tract 4.

In the intake tract 4, the fresh air 24 enriched with hydrocarbons 23 mixes with the fresh air 24 which is drawn in via the air filter 6. Thus the hydrocarbons 23 can be supplied to the internal combustion engine 2, where the hydrocarbons 23 are burned in the combustion chambers of the internal combustion engine 2. Since the fuel tank system 1 contains highly volatile hydrocarbons 24, it is necessary to test the tightness of the entire fuel tank system 1 regularly.

An essential part of the fuel tank system 1 shown in FIG. 1 is a valve unit 9. In this example, the valve unit 9 consists of a first valve 11, a second valve 12, a third valve 13, a fourth valve 14 and a fifth valve 15. The fifth valve 15 together with the purge air valve 10 serves for the complete sealing of the fuel tank system 1. Thus if the fifth valve 15 and the purge valve 10 are closed, and there are no leaks in the fuel tank system, the pressure present in the fuel tank system 1 on closure of the fifth valve 15 and purge air valve 10 will be maintained constantly until one of these valves is opened again. This constant pressure can be detected by the pressure sensor 8 and monitored by the control unit 25.

The first valve 11, the second valve 12, the third valve 13 and the fourth valve 14—which are part of the valve unit 9—serve to reverse the direction of flow of the fresh air 24, whereby firstly fresh air 24 can be conveyed by the purge air pump 7 in the direction of the internal combustion engine 2, and secondly fresh air 24 can be conveyed by the purge air pump 7 into the fuel tank 16. To purge the storage element 19, the purge air valve 10 is opened and in the valve unit 9, the second valve 12, the fourth valve 14 and the fifth valve 15 are opened. The first valve 11 in the valve unit 9 and the third valve 13 in the valve unit 9 are closed.

If the purge air pump 7—which is configured as a radial pump and hence can convey the medium to be pumped only from the suction side 21 to the pressure side 22—is now operated, fresh air is supplied from the purge air filter 20 via the purge air valve 10, through the storage element 19, to the intake tract 4 of the internal combustion engine 2. In this configuration therefore the storage element 19, which may be configured as an active charcoal filter, is flushed with fresh air 24, wherein the hydrocarbons 23 deposited in the storage element 19 are flushed out and supplied to the internal combustion engine 2. If the storage element 19 need not be purged, because for example it only has a low charge of hydrocarbons 23, the purge air valve 10 can be closed.

In addition, the second valve 12 and the fourth valve 14 in the valve unit 9 can also be closed. Initially the fifth valve 15 remains open. If the purge air pump 7 is now operated, fresh air 24 is drawn in via the air filter 6 and pressed in the direction of the storage element 19 and the fuel tank 17. Thus a controlled pressure rise occurs in the fuel tank system 1. The pressure rise in the fuel tank system 1 may be monitored via the pressure sensor 8 and/or the rotation speed or power consumption of the purge air pump 7. For this, both the pressure sensor 8 and the purge air pump 7 are connected to an electronic control unit 25. All said valves 10, 11, 12, 13, 14, 15 can also be controlled by the control unit 25.

Also, at least one temperature sensor 39 may be connected to the control unit. If now the fuel tank system is pressurized to a predefined pressure, the fifth valve 15 may be shut off, whereby the pressure built up in the fuel tank system 1 remains constant as long as there are no leaks in the fuel tank system 1. Using the fuel tank system 1 described here, during normal operation of a motor vehicle, the tightness of the fuel tank system 1 can be checked regularly, which is an important requirement arising from the regulations for protection of the environment and atmosphere.

Because of the valve unit 9, the radial pump 7—which, because of its construction, can only convey the medium to be conveyed in one direction, namely from the suction side 21 to the pressure side 22—can be used both for purging the storage element 19 and for pressurizing the fuel tank system 1. The very simple, durable and economic radial pump 7 used as a purge air pump, in cooperation with the valve unit 9, can fulfil a double function, so the entire fuel tank system becomes both economic and efficient.

By means of the temperature sensors 39 which may be arranged at various positions on the fuel tank system 1, a correlation can be created between the pressure generated by the radial pump 7 and the rotation speed with which it is driven or the power which it consumes. Thus the positive pressure generated in the fuel tank system 1 can easily be monitored by the control unit 25 on the basis of the power consumption of the radial pump 7.

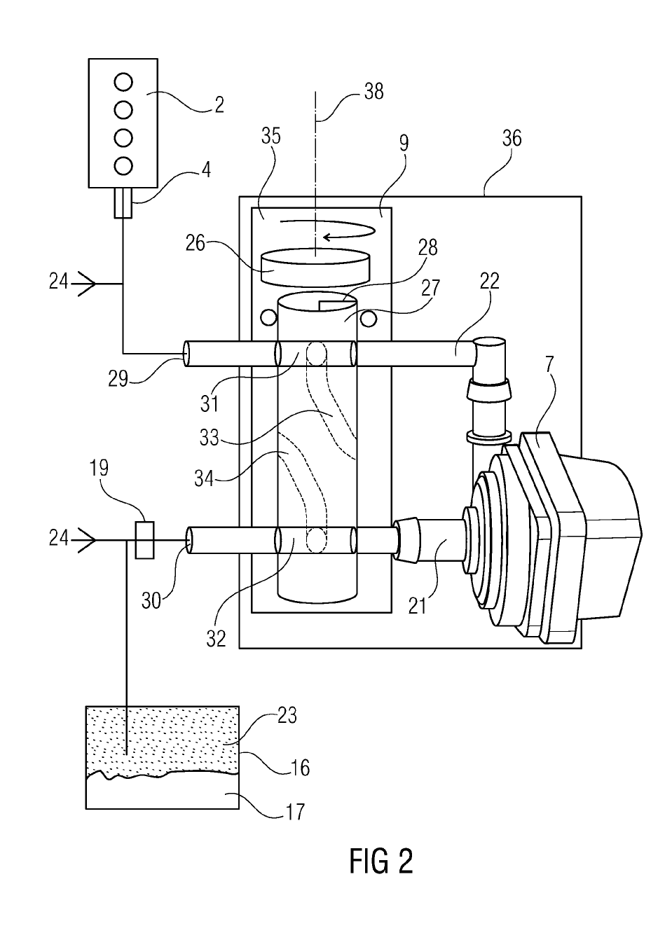

One configuration of the valve unit 9 is described in FIGS. 2 to 4. The valve unit 9 has an adjustment element 27 and a first to a sixth adjustment element passage (31, 32, 33, 34, 40, 41). The adjustment element 27 may be configured for example as a linear slider which is mounted movably in the valve unit 9, wherein the linear slider has six bores forming the first to sixth adjustment element passages (31, 32, 33, 34, 40, 41). In the example below, the invention is explained with reference to a valve unit 27 in which the adjustment element 27 is configured as a valve cylinder, wherein the first to sixth adjustment element passages (31, 32, 33, 34, 40, 41) are configured as first to sixth valve cylinder passages.

FIG. 2 shows the purge air pump 7 which is connected to the valve unit 9 on its suction side 21 and its pressure side 22. In this figure and the following figures, the purge air pump 7 and the valve unit 9—as already shown in FIG. 1—may be connected electrically to a control unit 25. The control unit 25 may for example move the valve cylinder 27 into various positions. In FIG. 2, the valve cylinder 27 is in a first position and is provided with a first valve cylinder passage 31 and a second valve cylinder passage 32. The first to sixth valve cylinder passages are intended to conduct air or an air-hydrocarbon mixture through the valve cylinder 27.

Using the valve drive 26, the valve cylinder 27 may be rotated about a rotation axis 38 into the first position. The first position of the valve cylinder 27, in which the first valve cylinder passage 31 connects the pressure side 22 of the purge air pump 7 to the first line 29 leading to the internal combustion engine 2, is marked with cylinder position marking 28. In this first position, the suction side 21 is also connected by means of the second valve cylinder passage 32 to the second line 30, which leads via the storage element 19 to the fuel tank 16. In this first position of the valve cylinder 27, the storage element 19 can be purged since fresh air 24 is aspirated via the second line 30, wherein it passes through the storage element 19 and is conveyed via the suction side 21 to the pressure side 22 by the purge air pump 7, and is then conducted via the first valve cylinder passage 31 and the first line 29 to the intake tract 4 of the internal combustion engine 2.

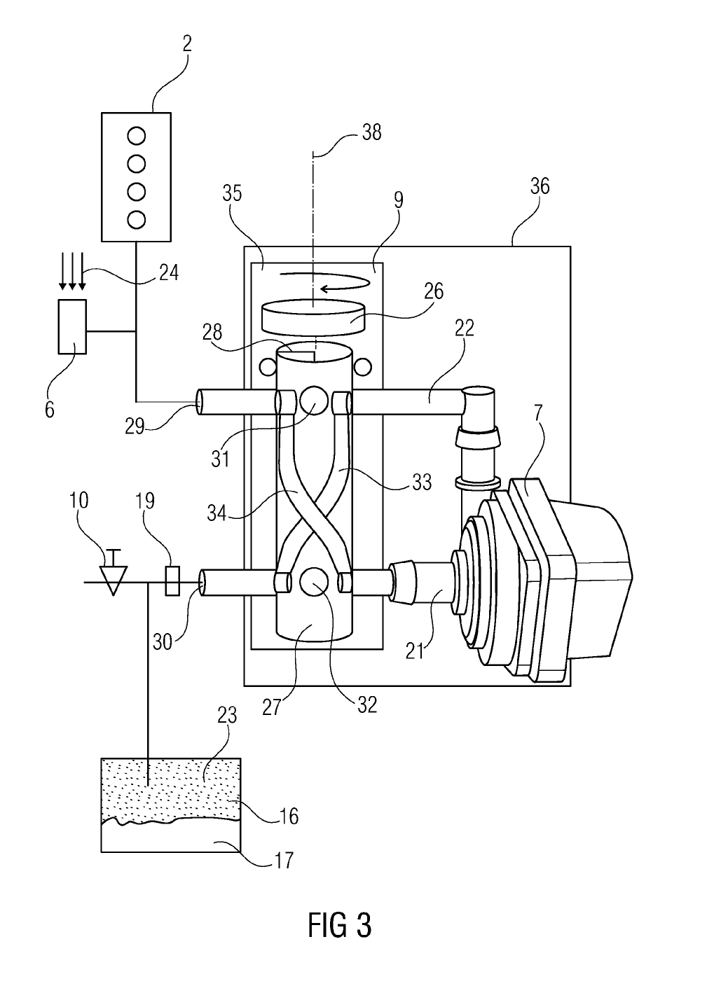

The valve unit 9 has a valve housing 35 in which the valve cylinder is mounted. The valve cylinder 27 can be rotated about a rotation axis 38 via a valve drive 26. When the valve cylinder 27 is rotated about the rotation axis 38 by means of the valve drive 26, which may be configured as an electric motor, the valve unit 9 can reverse the direction of flow of the fresh air 24, whereby the fresh air 24 is no longer conveyed by the purge air pump 7 towards the internal combustion engine 2, but fresh air 24 is conveyed by the purge air pump 7 to the fuel tank. This situation is shown in FIG. 3.

In FIG. 3, the valve cylinder 27 is rotated through 180 degrees about the rotation axis 38 into its second position, which can be identified by the cylinder position marking 28. Now neither the first valve cylinder passage 31 nor the second valve cylinder passage 32 is connected to the suction side 21 or pressure side 22 of the purge air pump 7. However, a third valve cylinder passage 33 and a fourth valve cylinder passage 34 are connected to the suction side 21 and pressure side 22 respectively. If now the purge air pump 7 is set in operation, fresh air 24 is drawn in via the air filter 6 and conveyed to the suction side 21 of the purge air pump 7 via the first line 29 which is connected to the fourth valve cylinder passage 34.

The purge air pump 7 then presses this fresh air 24 via the pressure side 22 and the third valve cylinder passage 33 towards the second line 30, whereby a pressure is built up in the fuel tank system 1, i.e. in the fuel tank 16 itself, and in the storage element 19 and in the connected lines. For this, evidently the purge air valve 10 must be closed. When a sufficient pressure has been built up in the fuel tank system 1 by the purge air pump 7, the valve cylinder 27 can be rotated for example by a further 90 degrees about the rotation axis 38 by the valve drive 26, whereby neither the first valve cylinder passage 31 nor the second valve cylinder passage 32, nor the third valve cylinder passage 33 nor the fourth valve cylinder passage 34, is connected to the suction side 21 or pressure side 22, or to the first line 29 or second line 30 respectively. In this position of the valve cylinder 27, the entire fuel tank system 1 is closed pressure-tightly as long as there are no leaks in the fuel tank system 1.

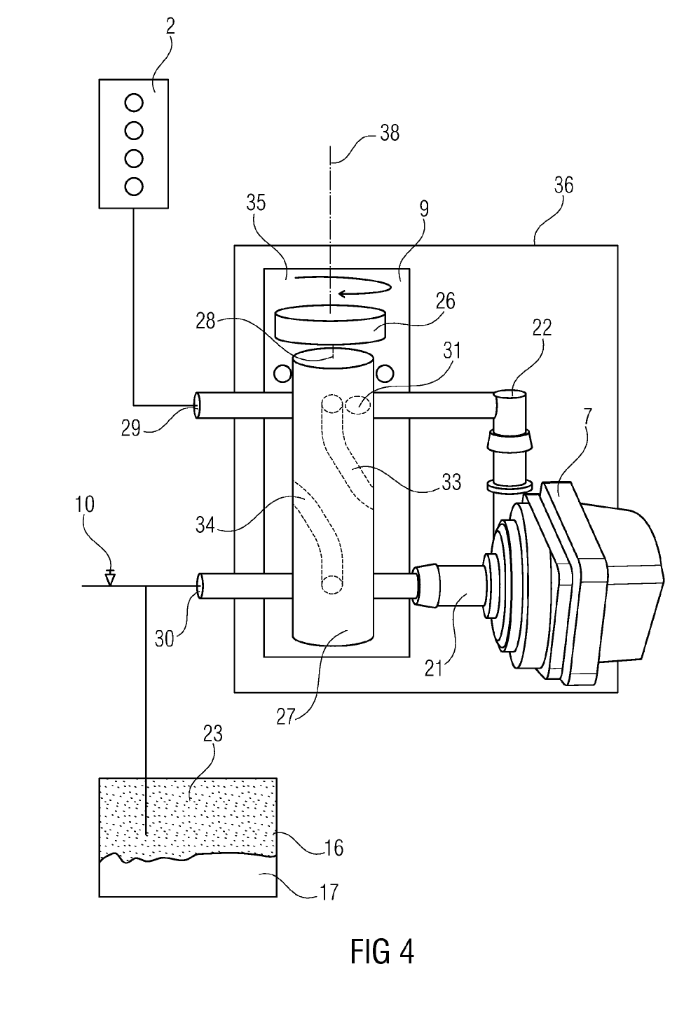

The third position of the valve cylinder 27 shown in FIG. 4 constitutes a possible embodiment of the closed fifth valve 15 from FIG. 1. If the entire fuel tank system 1 is pressurized and closed pressure-tightly by the position of the valve cylinder 27 shown in FIG. 4 and a closed purge air valve 10, by means of the pressure sensor 8 it can be checked whether the pressure present in the fuel tank system 1 is falling, which would indicate a leak in the fuel tank system 1. This is an important monitoring function for modern fuel tank systems 1 in order to prevent the uncontrolled escape of hydrocarbons 23 from the fuel tank system 1.

The purge air pump 7 and the valve unit 9 may be formed in a common housing 36, whereby the system of purge air pump 7 and valve unit 9 can easily be hermetically sealed. In this way, an escape of hydrocarbons 23 from the system of purge air pump 7 and valve unit 9 can be effectively prevented.

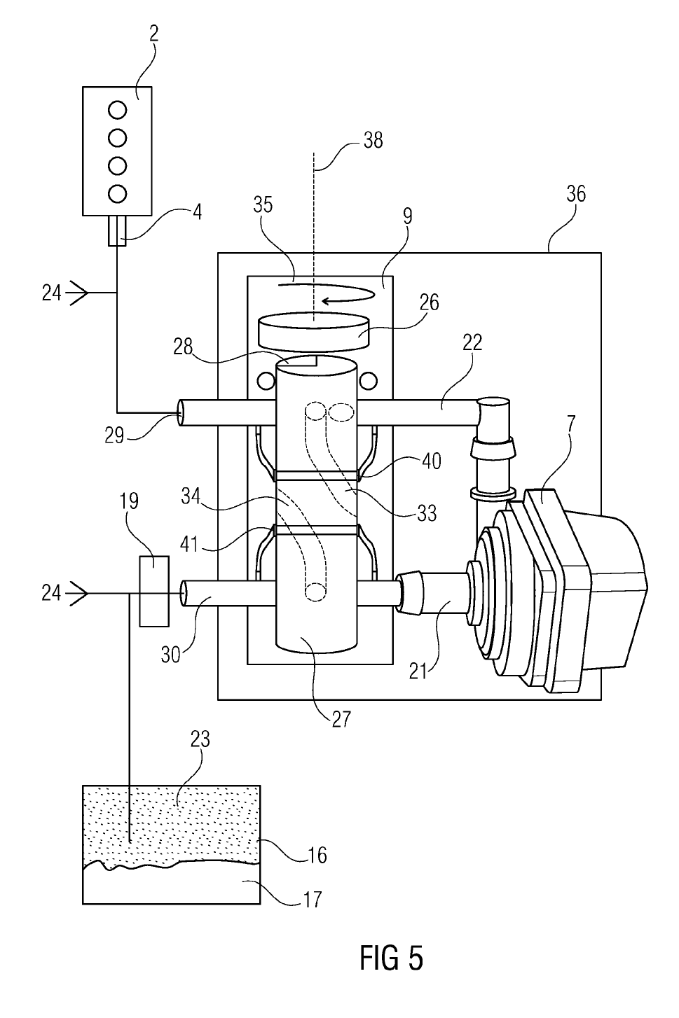

FIG. 5 shows a fourth position of the valve cylinder 27. The fourth position of the valve cylinder 27 can be identified from the orientation of the cylinder position marking 28. The valve cylinder 27, as well as the first valve cylinder passage 31, second valve cylinder passage 32, third valve cylinder passage 33 and fourth valve cylinder passage 34, has a fifth valve cylinder passage 40 and a sixth valve cylinder passage 41. The flow cross-sections of the fifth valve cylinder passage 40 and the sixth valve cylinder passage 41 are smaller than the flow cross-sections of the first valve cylinder passage 31 and the second valve cylinder passage 32, which is clearly shown in FIG. 5.

In the fourth position of the valve cylinder 27, the fifth valve cylinder passage 40 connects the pressure side 22 of the purge air pump 7 to the first line 29. Furthermore, the sixth valve cylinder passage 41 connects the suction side 21 of the purge air pump 7 to a second line 30; if the purge air pump 7 is now driven, fresh air 24 can be drawn in through the storage element 19 and conveyed via the second line and the sixth valve cylinder passage 41 to the purge air pump 7. Hydrocarbons 23 are now released from the storage element 19 and conveyed by the purge air pump 7 via the pressure side 22 and the fifth valve cylinder passage 40 to the first line 29, which in turn is connected to the intake tract 4 of the internal combustion engine 2. Due to the smaller flow cross-section of the fifth valve cylinder passage 40 and sixth valve cylinder passage 41, the storage element 19 can be purged with a very low purge rate. Because of the smaller flow cross-section in the fifth valve cylinder passage 40 and sixth valve cylinder passage 41, the purge air pump 7 can be regulated very finely with low purge rates, whereby very small volume flows can be produced, which leads to a highly efficient purging of the storage element 19.

What is claimed is:

1. A valve unit for use in a fuel tank system of an internal combustion engine having a fuel tank and a storage element for temporary storage of hydrocarbons, wherein the fuel tank and the storage element are connected together such that the hydrocarbons which gasify out of a fuel in the fuel tank are stored in the storage element, the valve unit comprising:
a purge air pump connected to the storage element and conveying fresh air to the storage element, thereby releasing the stored hydrocarbons and supplying them to a combustion chamber of the internal combustion engine;
a movable adjustment element with at least two positions;
wherein, in a first position of the adjustment element, a first passage connects a pressure side of the purge air pump to a first line and a second passage connects a suction side of the purge air pump to a second line, and in a second position of the adjustment element, a third passage connects the pressure side of the purge air pump to the second line and a fourth passage connects the suction side of the purge air pump to the first line.

2. The valve unit as claimed in claim 1, wherein in a third position of the adjustment element, the adjustment element separates the suction side and the pressure side of the purge air pump from the first line.

3. The valve unit as claimed in claim 1, wherein the adjustment element comprises a fifth adjustment element passage and a sixth adjustment element passage, and wherein cross-sections of the fifth passage and the sixth passage are smaller than cross-sections of the first passage and the second passage.

4. The valve unit as claimed in claim 3, wherein in a fourth position of the adjustment element, the fifth passage connects the pressure side of the purge air pump to the first line and the sixth passage connects the suction side of the purge air pump to the second line.

5. The valve unit as claimed in claim 1, wherein the purge air pump comprises a radial pump.

6. The valve unit as claimed in claim 1, wherein the storage element comprises an active charcoal filter.

7. The valve unit as claimed in claim 1, further comprising a pressure sensor disposed in the fuel tank system.

8. The valve unit as claimed in claim 1, wherein in a third position of the adjustment element, the adjustment element separates the suction side and the pressure side of the purge air pump from the second line.

9. The valve unit as claimed in claim 1, wherein in a third position of the adjustment element, the adjustment element separates the suction side and the pressure side of the purge air pump from both the first line and the second line.
